(19) United States
(12) Patent Application Publication
(10) Pub. No.: US 2018/0056714 A1
(43) Pub. Date: Mar. 1, 2018

(54) METALLIC WHEEL GARNISH

(71) Applicant: TOYODA GOSEI CO., LTD., Kiyosu-shi (JP)

(72) Inventors: Yuhki MAJI, Kiyosu-shi (JP); Tomokazu NISHIKAWA, Kiyosu-shi (JP); Tatsuya OBA, Kiyosu-shi (JP)

(21) Appl. No.: 15/617,118

(22) Filed: Jun. 8, 2017

(30) Foreign Application Priority Data
Aug. 26, 2016 (JP) 2016-166174

(51) Int. Cl. B60B 7/02; B60B 7/06; B60B 7/04

(52) U.S. Cl. CPC B60B 7/02; B60B 7/06; B60B 2900/572; B60B 2360/10; B60B 2360/30; B60B 7/04

(57) ABSTRACT

A garnish attached to a metallic wheel includes a nonmetallic base member and a metallic design part, in which the design part configures part of a surface of the garnish, the base member has a wheel adjacent portion configuring different part of the surface of the garnish, and the wheel adjacent portion is positioned closer to the wheel than the design part is when the garnish is attached to the wheel.

### BACKGROUND

### 1. Technical Field

The present invention relates to a garnish attached to a metallic wheel.

### 2. Related Art

There has conventionally been known a technique of covering a metallic wheel, which is mounted with a vehicle tire, with a resin decorative member called a wheel cap or a wheel cover.

The applicants of the present invention have developed a decorative member that is of a type of a wheel decorative member and is smaller than the above wheel cap (see Japanese Unexamined Patent Publication No. 2009-23411 and the like). The decorative member of this type is called a garnish and is attached onto a wheel spoke, between adjacent spokes, or the like. The garnish, which is made of a resin and is small in size, achieves high flexibility in shape and can thus provide a wheel with excellent design differentiating from the conventional wheel cap.

The wheel cap and the garnish are occasionally provided with a metallic design surface to achieve appearance integral with the metallic wheel. Such a metallic design surface is typically provided on the entire surface of a base member made of a nonmetallic material such as a resin by means of plating, coating, or the like. The wheel cap and the garnish having such a metallic design surface can provide a wheel with excellent design.

In particular, the garnish is a member attached onto the wheel spoke or between the adjacent spokes as described earlier. Unlike the decorative member such as the wheel cap attached to the wheel so as to cover the entire surface of the wheel, the garnish and the wheel attached thereto form a boundary easily visually recognized. Adequate integral appearance between the garnish and the wheel can be achieved by disposing the garnish and the wheel as close as possible at the boundary.

The garnish and the wheel disposed closely at the boundary may scrape each other during attachment work, travel, and the like. Particularly in a case where the design surface is made of a metal, scrape between the garnish and the wheel may cause damage to the design surface or the wheel and deteriorate design of the wheel or the garnish.

The garnish and the wheel disposed closely at the boundary may further cause the wheel and the design surface to be connected with each other via a water layer in rainy weather and the like. A wheel and a design surface made of different metals may cause galvanic corrosion between the wheel and the design surface to deteriorate the wheel or the design surface. A wheel and a design surface made of different metals largely different in potential will cause more deterioration. The wheel and the conventional garnish thus need to have a large gap therebetween at the boundary to suppress design deterioration of the garnish through the galvanic corrosion and the like. This conflicts with a circumstance that such a large gap deteriorates design at the boundary between the wheel and the garnish integrated with each other.

### SUMMARY

The present invention has been devised in view of the above circumstance, and an object thereof is to provide a metallic wheel garnish that will suppress design deterioration and achieve excellent design when attached to a wheel.

In order to achieve the object, the present invention provides a metallic wheel garnish attached to a metallic wheel, the metallic wheel garnish including a nonmetallic base member and a metallic design part, in which the design part configures part of a surface of the garnish, the base member has a wheel adjacent portion configuring different part of the surface of the garnish, and the wheel adjacent portion is positioned closer to the wheel than the design part is when the garnish is attached to the wheel.

The metallic wheel garnish according to the present invention will suppress the design deterioration and achieve the excellent design when attached to the wheel.

### BRIEF DESCRIPTION OF DRAWINGS

FIG. 1 is a schematic enlarged front view of a main part of a garnish according to a first embodiment attached to a wheel;

FIG. 2 is a schematic sectional view taken along line A-A indicated in FIG. 1, of the garnish according to the first embodiment attached to the wheel;

FIG. 3 is an enlarged rear perspective view of the garnish according to the first embodiment, depicting a main part including a bolt mount and a bolt attached to the mount;

FIG. 4 is an enlarged rear perspective view of the garnish according to the first embodiment, depicting a main part including a clip mount and a clip attached to the mount;

FIG. 5 is a schematic sectional view taken along a line positioned identically with line A-A indicated in FIG. 1, of a garnish according to a second embodiment; and

FIG. 6 is a schematic enlarged front view of a main part of a garnish according to a third embodiment attached to a wheel.

### DETAILED DESCRIPTION

As described earlier, a metallic wheel garnish according to the present invention is a member for providing the vehicle metallic wheel with design. The metallic wheel garnish according to the present invention may simply be called the garnish where appropriate in this application.

The garnish according to the present invention includes a nonmetallic base member and a metallic design part. The garnish has a surface, part of which is configured by the design part and different part of which is configured by a wheel adjacent portion as part of the base member.

The wheel adjacent portion is positioned closer to the wheel than the design part is in a garnish attached state where the garnish is attached to the wheel. In other words, the garnish according to the present invention includes a nonmetallic wheel adjacent portion interposed between the metallic wheel and the metallic design part. This state can also be expressed such that the wheel adjacent portion serves as a spacer to physically separate the wheel and the design part.

The wheel and the design part separated from each other are thus less likely to be connected via a water layer even under a condition where galvanic corrosion tends to occur between the wheel and the design part in rainy weather and the like. They are thus less likely to be electrically connected with each other. That is, the garnish according to the present invention is less likely to cause the galvanic corrosion between the design part of the garnish and the wheel. Furthermore, the base member configuring the wheel adjacent portion is made of nonmetallic material, so that the wheel and the wheel adjacent portion will not cause the galvanic corrosion therebetween even in a state where they are connected with each other via the water layer. The garnish according to the present invention thus suppresses deterioration of the wheel and design of the design part due to the galvanic corrosion even when the wheel and the garnish are disposed close to each other. The garnish according to the present invention will achieve and maintain excellent design in the attached state.

When a selected nonmetallic material for the base member is softer than a metallic material for the wheel, damage to at least the wheel, which is typically more expensive than the garnish, can be suppressed even in a case where the wheel adjacent portion and the wheel scrape each other at the boundary during travel and the like as described above.

The garnish according to the present invention includes the base member that has only to be made of the nonmetallic material. Various materials other than metals are selectable as the material for the base member. Specific examples thereof include a resin, rubber, and ceramics. The selected material for the base member is preferred to be soft for suppression of damage to the wheel when the garnish and the wheel scrape each other, and is preferably a resin.

The metallic material for the design part is not particularly limited, and examples thereof include a metal similar to the metallic material for the wheel as well as a metal different therefrom. The design part and/or the wheel can optionally be rustproofed. In any of these cases, the garnish according to the present invention suppresses the deterioration of the wheel and design of the design part due to the galvanic corrosion. A single garnish can be provided with a single design part or a plurality of design parts.

### Embodiments

The garnish according to the present invention will be described below with reference to specific examples.

### First Embodiment

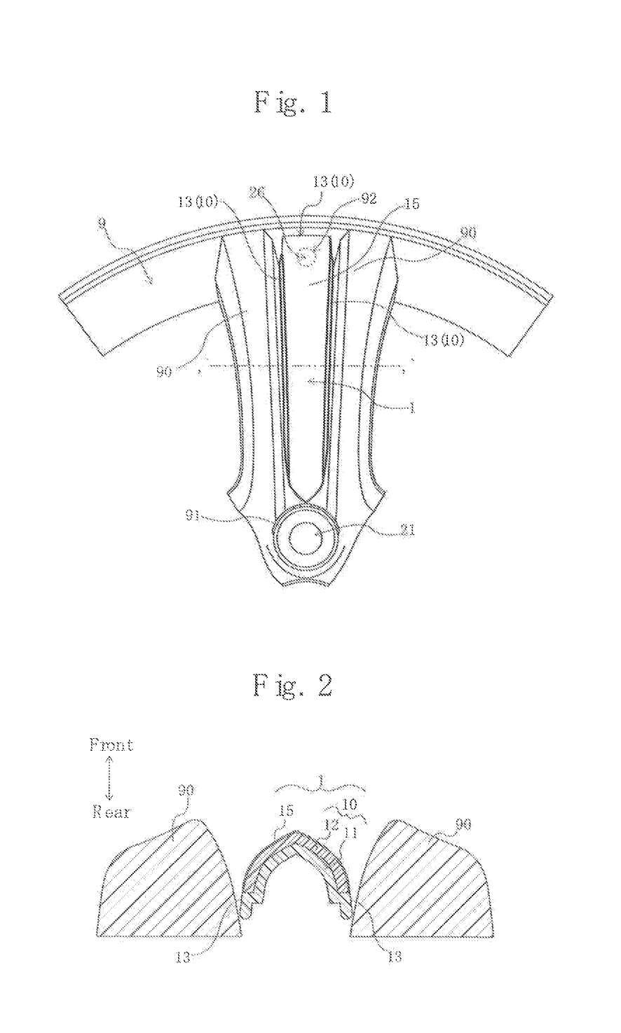

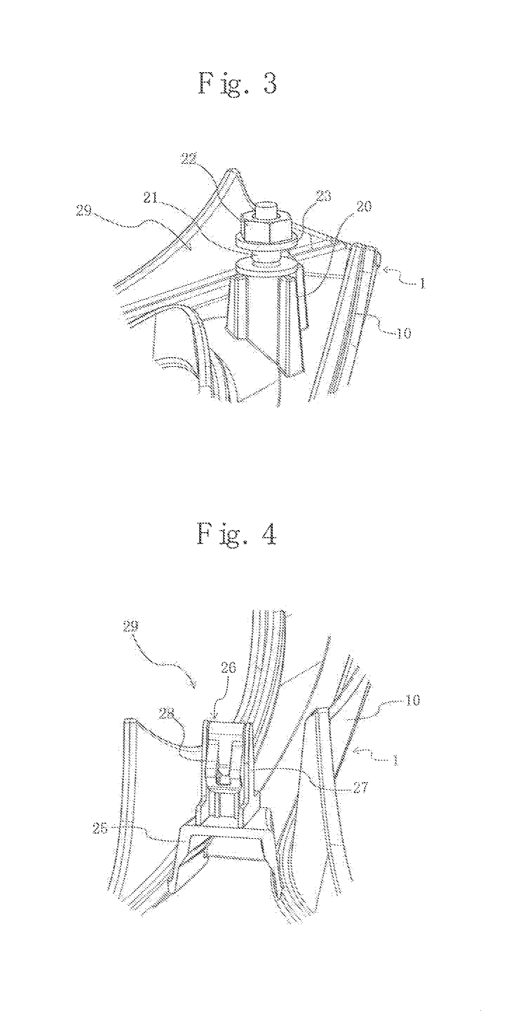

A garnish according to the first embodiment is attached to an aluminum wheel. FIGS. 1 to 4 are schematic explanatory views of the garnish according to the first embodiment. Specifically, FIG. 1 is a schematic enlarged front view of a main part of the garnish according to the first embodiment attached to the wheel. FIG. 2 is a schematic sectional view taken along line A-A indicated in FIG. 1, of the garnish according to the first embodiment attached to the wheel. FIGS. 3 and 4 are schematic enlarged rear perspective views depicting a main part of the garnish according to the first embodiment. Specifically, FIG. 3 depicts a bolt mount of the garnish according to the first embodiment, as well as a bolt and a nut attached to the mount. FIG. 4 depicts a clip mount of the garnish according to the first embodiment, and a clip attached to the mount.

As depicted in FIGS. 1 and 2, a garnish 1 according to the first embodiment is a pillar member having a U sectional shape. As depicted in FIG. 2, the garnish 1 in an attached state as in FIGS. 1 and 2 has a projecting surface directed forward and a recessed surface directed backward. As depicted in FIG. 2, the garnish 1 includes a resin base member 10 and a design part 15 provided as a chromium plating layer.

As depicted in FIG. 1, a wheel 9 has a large number of radially extending spokes 90, and the garnish 1 attached to the wheel 9 at a position between two adjacent spokes 90. The garnish 1 has a front surface portion configured by the design part 15 and a rear surface portion configured by the base member 10. The design part 15 accordingly configures part of a surface of the garnish 1, specifically, a front surface of the garnish 1.

The base member 10 has a two-layer structure including a base layer 11 made of a polycarbonate resin including an additive of black pigment, and a primer layer 12 made of an ABS resin. The base member 10 is molded by a two-color molding method. The primer layer 12 is disposed ahead of the base layer 11.

The base layer 11 configures the entire rear surface of the base member 10 and a surface of a peripheral edge part of the base member 10. The primer layer 12 configures a surface of the base member 10 other than the peripheral edge part, in other words, a front surface of the base member 10 other than the peripheral edge part. As depicted in FIG. 2, the surface of the peripheral edge part of the base member 10 configures a wheel adjacent portion 13 adjacent to the wheel 9 in the attached state. The base layer 11 of the garnish 1 according to the first embodiment thus configures the wheel adjacent portion 13 and the entire rear surface of the base member 10. The base layer 11 is part of the base member 10, so that the base member 10 has the wheel adjacent portion 13 in the garnish 1 according to the first embodiment.

The design part 15 corresponds to a chromium plating layer formed on the primer layer 12 by electroless plating. The design part 15 is provided only on the primer layer 12 and is not provided on the base layer 11. The design part 15 accordingly configures part of the surface of the garnish 1 exclusive of the wheel adjacent portion 13.

As depicted in FIG. 2, the portion of the garnish 1 adjacent to the wheel 9, namely, the wheel adjacent portion 13, is configured by the resin base member 10. The wheel adjacent portion 13 is made of a nonmetallic material, so that no galvanic corrosion will be caused between the wheel 9 and the wheel adjacent portion 13 in rainy weather and the like. The wheel adjacent portion 13, which is made of a resin, and the wheel 9 are less likely to be damaged even when the wheel adjacent portion 13 and the wheel 9 scrape each other during travel of a vehicle and the like. The wheel adjacent portion 13 can thus be disposed adjacent to the wheel 9, and the garnish 1 according to the first embodiment can be attached to the wheel 9 at a position adjacent to the wheel 9.

The garnish 1 according to the first embodiment thus achieves excellent design in the attached state and suppresses damage such as galvanic corrosion and abrasion to maintain the excellent design.

For reference, a garnish including the wheel adjacent portion 13 and the design part 15 made of a same metal needs a gap of 1.3 mm between the wheel adjacent portion 13 and the wheel 9 in the attached state for suppression of galvanic corrosion. In contrast, the garnish 1 according to the first embodiment needs such a gap as small as 0.5 mm.

The garnish 1 according to the first embodiment includes the base member 10 that is made of a resin selected as a nonmetallic material. Resin is relatively soft and is less likely to damage the wheel 9 by abrasion and the like even upon scraping the wheel 9. Resin also has certain elasticity to be less likely to be damaged by abrasion and the like.

In the garnish 1 according to the first embodiment, polycarbonate included in the base layer 11 of the base member 10 has excellent mechanical properties such as shock resistance, weather resistance, and softness, and is thus preferably applied to a vehicle exterior member. On the other hand, it is hard to provide an electroless plating layer on polycarbonate. Formation of a highly adhesive electroless plating layer on a polycarbonate layer requires provision of an additional primer layer between the polycarbonate layer and the electroless plating layer.

Meanwhile, an ABS resin is inferior to polycarbonate in terms of the mechanical properties, but an ABS resin layer is easily provided thereon with an electroless plating layer having excellent mechanical properties. The base member 10 has the two-layer structure including the base layer 11 made of a polycarbonate resin and the primer layer 12 made of an ABS resin. The garnish 1 then obtains excellent mechanical properties derived from polycarbonate, and an ABS resin layer, i.e. the primer layer 12, can be provided thereon with an electroless plating layer, to provide the garnish 1 with excellent design with metallic luster. Furthermore, polycarbonate and an ABS resin achieve excellent affinity, so that combined use of which advantageously provides the base member 10 with excellent mechanical properties. The garnish 1 according to the first embodiment includes the base member 10 having the two-layer structure of the polycarbonate and the ABS resin, to achieve excellent design and excellent mechanical properties.

The base member 10 has two mounts projecting to the rear surface side of the garnish 1. The two mounts are disposed apart from each other in a longitudinal direction of the garnish 1 having the pillar shape.

As depicted in FIG. 3, the mounts include a bolt mount 20 fixing a bolt 21. The bolt 21 is inserted to a bolt-fastening part 91 of the wheel 9 and is fastened by a nut 22 and a washer 23.

As depicted in FIG. 4, the mounts also include a clip mount 25 fixing a clip 26. The clip 26 includes a resin clip basal portion 27 and an elastic retainer 28 configured by a plate spring, and is fixed to a clip attachment 92 of the wheel 9 mainly by elasticity of the elastic retainer 28.

The bolt 21 is fixed to the bolt-fastening part 91 positioned radially inside the wheel 9. The clip 26 is fixed to the clip attachment 92 positioned radially outside the wheel 9. The clip 26, as well as the bolt 21, the nut 22, and the washer 23 configure part of the garnish 1 according to the present invention. The clip 26, the clip mount 25, as well as the bolt 21, the nut 22, the washer 23, and the bolt mount 20 configure attachments 29 of the garnish 1 to the wheel 9.

The garnish 1 according to the first embodiment, which includes the attachment 29 (called a bolt-nut attachment 29) having the bolt 21, the nut 22, and the washer 23, and the attachment 29 (called a clip attachment 29) having the clip 26, achieves excellent fixing strength as well as attachment workability to the wheel 9.

The bolt-nut attachment 29 can firmly fix the garnish 1 to the wheel 9. On the other hand, the bolt-nut attachment 29 achieves low positional flexibility of the garnish 1 attached to the wheel 9. In particular, the bolt-nut attachment 29 made of a metal achieves very low flexibility.

Specifically, the garnish 1 is a small member and can thus be molded relatively accurately with a tolerance of about ±0.3 mm. In contrast, the wheel 9 is a large member having a relatively large tolerance of about ±1.0 mm. In other words, the wheel 9 is relatively larger in dimensional error than the garnish 1. When the garnish 1 is attached to the wheel 9 by the bolt-nut attachment 29, the garnish 1 is attached to the wheel 9 at a substantially designed position. It is thus difficult for the garnish 1 to cancel the dimensional error of the wheel 9. An excessively large dimensional error of the wheel 9 may complicate work of attaching the garnish 1 to the wheel 9 or prevent the garnish 1 from being attached to the wheel 9.

In contrast, the clip attachment 29 is deformably configured by the clip basal portion 27 made of a resin and the elastic retainer 28 made of a metal and mounted to the clip basal portion 27. The clip attachment 29 is thus configured to attach the garnish 1 to the wheel 9 even at a position somewhat displaced from a preliminarily designed position. The clip attachment 29 is inferior to the bolt-nut attachment 29 in terms of fixing strength but has high attaching flexibility as described above to advantageously cancel the dimensional error of the wheel 9. The garnish 1 according to the first embodiment includes both the bolt-nut attachment 29 and the clip attachment 29 to achieve excellent fixing strength to the wheel 9 as well as attachment workability to the wheel 9.

The design part 15 is formed by the electroless plating in the garnish 1 according to the first embodiment. In order to form the design part 15 by the electroless plating, the design part 15 is preferably made of a metal selected from nickel, copper, cobalt, an alloy thereof, tin, gold, silver, solder, or the like. Alternatively, at least a portion in the base member 10 in contact with the design part 15 is preferably made of a resin adapted to electroless plating, such as ABS, a polymer alloy of PC and ABS, polysulfone, or Noryl resin. Examples of the metallic material for the design part 15 in this case include chromium and the like in addition to the above metals.

A method of forming the design part 15 is not limited to the electroless plating, but examples thereof also include ordinary methods of forming a metallic layer, such as coating, printing, and depositing.

The base member 10 is preferably made of a dark resin with low lightness. The wheel adjacent portion 13 of the base member 10 is exposed to the surface of the garnish 1 in the vicinity of the wheel 9. The dark base member 10 causes the wheel adjacent portion 13 to appear as a shadow of the wheel 9. Even in a case where the metallic wheel 9 and the nonmetallic wheel adjacent portion 13 have relatively large color difference at the boundary between the wheel 9 and the garnish 1, the color difference is visually recognized as if being caused by the shadow and the boundary appears naturally. Color difference between the nonmetallic wheel adjacent portion 13 and the metallic design part 15 similarly causes the wheel adjacent portion 13 to appear as a shadow of the design part 15.

Accordingly, the boundary also appears naturally between the wheel adjacent portion 13 and the design part 15.

The base member 10 has a color with lightness according to the Munsell color system preferably not more than five and more preferably not more than three. The base member 10 can be made of a black resin or a material including a transparent resin such as polycarbonate including an additive of a coloring agent such as black pigment as in the embodiment. Alternatively, the surface of the base member 10 can be colored in a dark color in accordance with any one of various methods such as coating, printing, and depositing.

### Second Embodiment

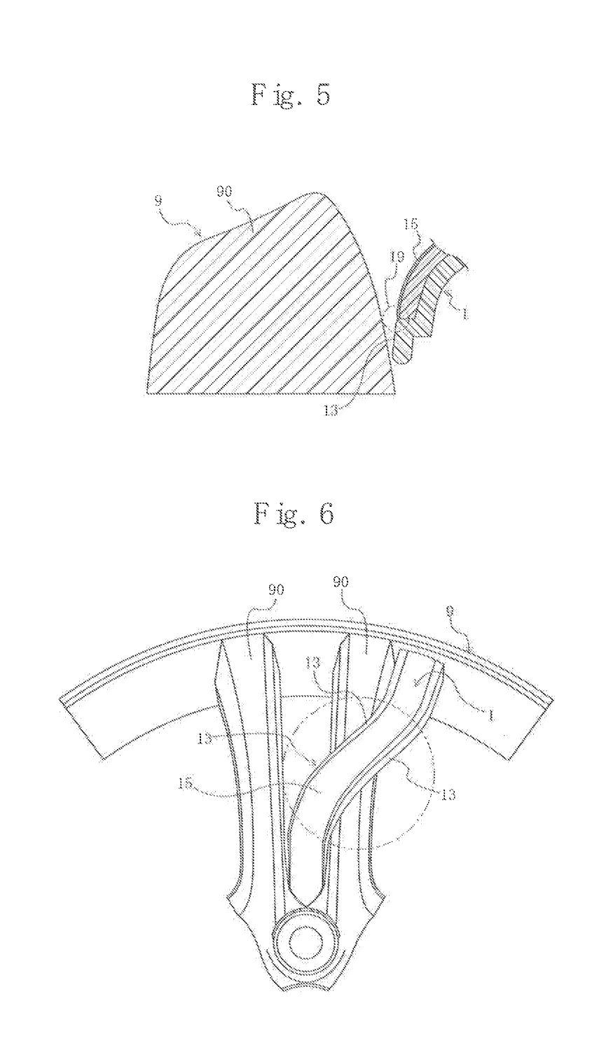

A garnish 1 according to the second embodiment is configured substantially similarly to the garnish 1 according to the first embodiment except a shape of the surface between the design part 15 and the wheel adjacent portion 13 of the base member 10. FIG. 5 is a schematic sectional view of the garnish 1 according to the second embodiment taken along a line positioned identically with line A-A indicated in FIG. 1.

As depicted in FIG. 5, the garnish 1 according to the second embodiment has a recessed boundary 19 between the wheel adjacent portion 13 and the design part 15. The recessed boundary 19 has an interior dented from the exterior to appear dark in a shadow. The boundary 19 between the wheel adjacent portion 13 and the design part 15 thus appears naturally, and the garnish 1 according to the second embodiment has excellent design.

### Third Embodiment

A garnish 1 according to the third embodiment is configured substantially similarly to the garnish 1 according to the first embodiment except a curved pillar shape to span the spoke 90 of the wheel 9 in an attached state. FIG. 6 depicts a front view of the garnish 1 according to the third embodiment attached to the wheel 9.

The garnish 1 according to the third embodiment spans the spoke 90 of the wheel 9 in the attached state. Specifically, similarly to the garnishes 1 of the first and second embodiments, the garnish 1 according to the third embodiment has the peripheral edge part disposed adjacent to the wheel 9 and the rear surface also disposed adjacent to the wheel 9. In other words, the garnish 1 according to the third embodiment has a portion with a larger area adjacent to the wheel 9 as compared with the garnishes 1 of the first and second embodiments.

In the garnish 1 according to the third embodiment, the front surface and the rear surface of the peripheral edge part correspond to the wheel adjacent portion 13 configured by the base member 10. The wheel adjacent portion 13 is made of a resin as in the garnishes 1 of the first and second embodiments. The garnish 1 according to the third embodiment thus has the wheel adjacent portion 13 having quite a large area, but suppresses damage such as corrosion to maintain excellent design. Similarly to the garnishes 1 of the first and second embodiments, the garnish 1 according to the third embodiment can be disposed adjacent to the wheel 9. The garnish 1 spanning the spoke 90 has a large boundary with the wheel 9 (particularly the spoke 90). If the garnish 1 and the spoke 90 are disposed separately from each other, the boundary is likely to be unnaturally recognized by a user. It is difficult to improve design in this case.

The garnish 1 according to the third embodiment includes the wheel adjacent portion 13 made of a resin to allow the garnish 1 and the wheel 9 to be disposed adjacent to each other. The boundary between the garnish 1 and the spoke 90 does not stand out to significantly improve design in this case.

### (Others)

The present invention is not limited to the embodiments described above and depicted in the drawings, but can be implemented with appropriate modifications within the range not departing from the gist thereof. Furthermore, the constituent elements exemplified in the embodiments can be extracted and combined appropriately.

### INDUSTRIAL APPLICABILITY

The garnish according to the present invention can be attached to a vehicle wheel to protect a vehicle tire and its vicinity and provide the vehicle with excellent appearance.

The garnish according to the present invention can be described as follows.
(1) A garnish 1 attached to a metallic wheel 9, the garnish 1 including a nonmetallic base member 10 and a metallic design part 15, in which the design part 15 configures the part of a surface of the garnish 1, the base member 10 has a wheel adjacent portion 13 configuring a different part of the surface of the garnish 1, and the wheel adjacent portion 13 is positioned closer to the wheel 9 than the design part 15 is when the garnish 1 is attached to the wheel 9.
(2) The garnish 1 described in (1), in which the design part 15 and the wheel 9 are made of metals different from each other.
(3) The garnish 1 described in (1) or (2), in which the base member 10 is made of resin, and the design part 15 is provided with a metallic plating layer.
(4) The garnish 1 described in any one of (1) to (3), in which the wheel adjacent portion 13 is black.
(5) The garnish 1 described in any one of (1) to (4), in which the garnish 1 has a plurality of attachments 29 to the wheel 9, and at least one of the attachments 29 is a clip attachment 26.

What is claimed is:

1. A garnish attached to a metallic wheel, the garnish comprising:
a nonmetallic base member and a metallic design part, wherein
the design part configures part of a surface of the garnish,
the base member has a wheel adjacent portion configuring different part of the surface of the garnish, and
the wheel adjacent portion is positioned closer to the wheel than the design part is when the garnish is attached to the wheel.

2. The garnish according to claim 1, wherein the design part and the wheel are made of metals different from each other.

3. The garnish according to claim 1, wherein the base member is made of resin, and the design part is provided with a metallic plating layer.

4. The garnish according to claim 1, wherein the wheel adjacent portion is black.

5. The garnish according to claim 1, wherein the garnish has a plurality of attachments to the wheel, and at least one of the attachments is a clip attachment.
